(19) United States
(12) Patent Application Publication
(10) Pub. No.: US 2015/0012828 A1
(43) Pub. Date: Jan. 8, 2015

(54) METHOD, DEVICE AND COMPUTER-READABLE STORAGE MEDIUM FOR PROGRESS BAR CONTROL

(71) Applicant: Tencent Technology (Shenzhen) Company Limited, Shenzhen (CN)

(72) Inventor: Yulong Wang, Shenzhen (CN)

(73) Assignee: Tencent Technology (Shenzhen) Company Limited, Shenzhen (CN)

(21) Appl. No.: 14/493,935

(22) Filed: Sep. 23, 2014

Related U.S. Application Data
(63) Continuation of application No. PCT/CN2013/090469, filed on Dec. 25, 2013.

(30) Foreign Application Priority Data
Jun. 13, 2013 (CN) 201310233626.2

(51) Int. Cl. H04L 29/06; G06F 3/0484

(52) U.S. Cl. CPC H04L 65/60; G06F 3/04847
USPC 715/720

(57) ABSTRACT

A method and device for progress bar control is disclosed. The method includes: acquiring an actual and current buffer progress from a data flow in an application; reducing a difference between the actual and current buffer progress to a lower order to obtain a variation of a progress bar; refreshing the progress bar based on the variation of the progress bar; and displaying the refreshed progress bar. The device includes: a buffer progress acquisition module, configured to acquire an actual and current buffer progress from a data flow in an application; a processing module, configured to reduce a difference between the actual and current buffer progress to a lower order to obtain a variation of a progress bar; a refreshing module, configured to refresh the progress bar based on the variation of the progress bar; and a display module, configured to display the refreshed progress bar.

### CROSS REFERENCE TO RELATED APPLICATIONS

This application is a continuation application of the PCT International Application No. PCT/CN2013/090469, filed on Dec. 25, 2013, entitled “METHOD, DEVICE AND COMPUTER-READABLE STORAGE MEDIUM FOR PROGRESS BAR CONTROL” by Yulong WANG, which claims the priority from Chinese Patent Application No. 201310233626.2, filed on Jun. 13, 2013. The above-referenced applications are incorporated by reference herein in their entirety for all purposes.

### FIELD OF THE INVENTION

The present disclosure relates to the Internet application technology, and more particularly, to a method, device, and computer-readable storage medium for progress bar control.

### BACKGROUND OF THE INVENTION

In network applications, a progress bar is a component in a graphical user interface used to visualize the progress of an extended computer operation, for example, in the process of uploading files, the progress bar can reflect a current uploading progress, and in the process of playing an online video, the progress bar can reflect a current loading progress.

However, the progress reflected by the progress bar will be influenced by data flow that the greater the flow rate of the data flow is, the faster the loading rate and the loading progress are, for example, data download speed is faster in a good network environment, and it brings continual sudden changes to the loading progress visualized in the progress bar, while data download speed is slower in a poor network environment, and if brings smooth changes to the loading progress visualized in the progress bar, so the progress visualized in the progress bar is suddenly changed with the network environment changing, and the progress bar can not be effectively controlled that the display of the progress bar is affected by network environment when the progress bar is reflecting a buffer progress.

### SUMMARY OF THE INVENTION

In view of the above, an object of the present disclosure is to provide a method for progress bar control, which can effectively control a progress bar that reduces the impact of network environment on the display of the progress bar when the progress bar is reflecting the progress.

It is a further object of the present disclosure to provide a device for progress bar control corresponding to the above method, which can effectively control a progress bar that reduces the impact of network environment on the display of the progress bar when the progress bar is reflecting the progress.

It is still a further object of the present disclosure to a computer-readable storage medium storing computer executable instructions.

According to one aspect of the disclosure, a method for progress bar control includes the steps of:

acquiring an actual buffer progress and a current buffer progress from a data flow in an application;

reducing a difference between the actual buffer progress and the current buffer progress to a lower order to obtain a variation of a progress bar;

refreshing the progress bar based on the variation of the progress bar; and

displaying the refreshed progress bar.

According to a further aspect of the disclosure, a device for progress bar control includes:

a buffer progress acquisition module, configured to acquire an actual buffer progress and a current buffer progress from a data flow in an application;

a processing module, configured to reduce a difference between the actual buffer progress and the current buffer progress to a lower order to obtain a variation of a progress bar;

a refreshing module, configured to refresh the progress bar based on the variation of the progress bar; and

a display module, configured to display the refreshed progress bar.

According to still a further aspect of the disclosure, a computer-readable storage medium for storing an executable program to execute a method for progress bar control, the method includes the following steps:

acquiring an actual buffer progress and a current buffer progress from a data flow in an application;

reducing a difference between the actual buffer progress and the current buffer progress to a lower order to obtain a variation of a progress bar;

refreshing the progress bar based on the variation of the progress bar; and

displaying the refreshed progress bar.

The above method and device for progress bar control, in the process of data buffering of an application, acquire an actual buffer progress and a current buffer progress from data in the application, reduce a difference between the actual buffer progress and the current buffer progress to a lower order to obtain a variation of a progress bar, refresh the progress bar based on the variation, and display the refreshed progress bar, to reflect the buffer progress of data in the application. Because the variation of the progress bar is the result of reducing the difference between the actual buffer progress and the current buffer progress to a lower order, and the difference is easily influenced by external factors, such as network environment, reducing the difference to a lower order correspondingly reduces the influence of external factors, and it makes the refreshed progress bar based on the variation of the progress bar both reflect the buffer progress of data in the application and be less susceptible to external factors, such as network environment, so as to effectively control the progress bar.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flow diagram illustrating a method for progress bar control according to one embodiment of the present disclosure.

FIG. 2 is a flow diagram illustrating a method for refreshing the progress bar based on the variation in FIG. 1.

FIG. 3 is a flow diagram illustrating a method for progress bar control according to another embodiment of the present disclosure.

FIG. 4 is a schematic diagram illustrating a device for progress bar control according to one embodiment of the present disclosure.

FIG. 5 is a schematic diagram illustrating a refreshing module in FIG. 4.

FIG. 6 is a schematic diagram illustrating a device for progress bar control according to another embodiment of the present disclosure.

### DETAILED DESCRIPTION OF THE PREFERRED EMBODIMENTS

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

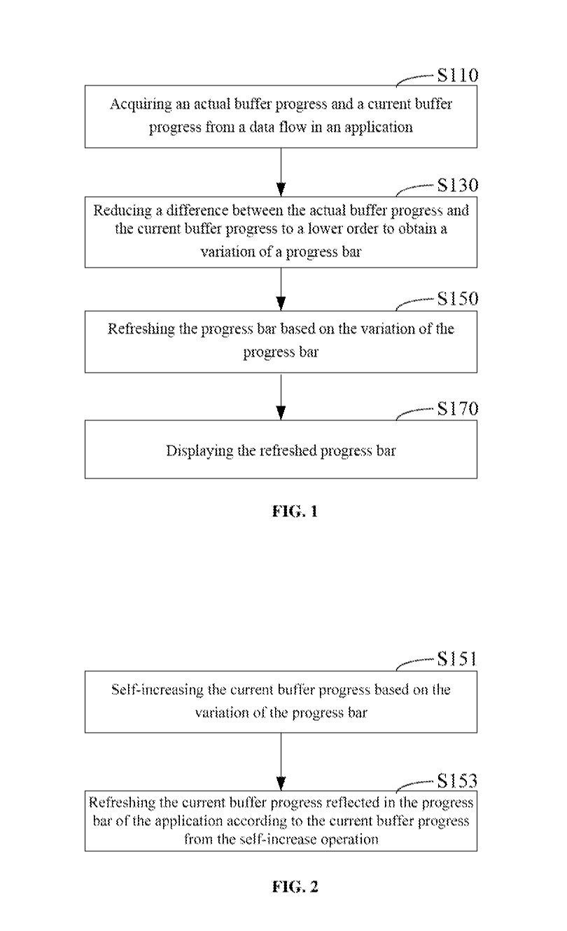

In one embodiment of the present disclosure, as shown in FIG. 1, a method for progress bar control includes the following steps.

Step S110, acquiring an actual buffer progress and a current buffer progress from a data flow in an application.

In the embodiment, the application can be an application that requires data buffering and loading and is provided with a progress bar, for example, the application can be an application for playing media online, or a application that is loading a page and provided with a progress bar reflecting the progress in the loading page, too many to mention here.

The actual buffer progress of a data flow is a download progress of the data flow or a progress that buffers data flow from local to memory, while the current buffer progress is a data flow buffer progress corresponding to the progress bar of the application.

The actual buffer progress can be acquired from the data buffer in the application, and the current buffer progress can be obtained by the progress bar of the application.

With the buffering of data in the application, the corresponding actual buffer progress and current buffer progress are constantly changing, for example, when a browser is loading a webpage game, the actual buffer progress will changes with the download progress of the data flow, while the current buffer progress is a progress corresponding to the progress bar in the webpage.

Further, depending on the source of data flow, the actual buffer progress of the data flow can be a download progress of the data flow or a progress that buffers data flow from local to memory. If the data flow comes from a network server, the application pulls data from the network server, and the actual buffer progress is a download progress for downloading from the network server accordingly. If the data flow is data stored in the local, it can not be buffered in a memory at once and needs a certain time to be loaded into memory, and the actual buffer progress is a ratio of data loaded into memory to actual data.

Step S130, reducing a difference between the actual buffer progress and the current buffer progress to a lower order to obtain a variation of a progress bar.

In the embodiment, the current buffer progress is subtracted from the actual buffer progress, yielding the difference between actual buffer progress and the current buffer progress, and reducing the difference to a lower order to obtain a variation of a progress bar, where the variation of the progress bar reduced to a lower order is not greater than the difference, which is used to indicate the actual variation of the progress bar.

Reducing the difference between the actual buffer progress and the current buffer progress to a lower order will be helpful for reducing the influence of various external factors, for example the impact of the situation of network on the progress bar. Specifically, under a very good network condition, the actual buffer progress is changing rapidly under the influence of network condition, and the current buffer progress is a progress reflected in the progress bar and corresponding to the actual buffer progress before the changes, at the moment, the difference between the actual buffer progress and the current buffer progress is larger, namely, the better the network condition is, the greater the difference is. If refresh the progress bar directly from the difference, the progress bar will be suddenly changed, so reducing the difference to a lower order to refresh the progress bar based on the reduced progress bar makes the current buffer progress in the progress bar increase smooth.

Further, preset an optimal variation value, and reduce the difference to a lower order based on the optimal variation value. The algorithm for reducing order of the difference can be flexible, for example, divide the difference by the factorial of 2, take remainders of the difference, or take remainders of the difference before divide the difference by the factorial of 2.

Step S150, refreshing the progress bar based on the variation of the progress bar.

In the embodiment, the actual variation of the progress bar can be learned by the variation of the progress bar, and the progress bar of the application can be refreshed by the actual variation.

Step S170, displaying the refreshed progress bar.

In the embodiment, display the refreshed progress bar in the page of the application to reflect the progress to users.

In the above method for progress bar control, lazy load the actual buffer progress of data flow in the application to the progress bar, to make the current buffer progress of the progress bar change smooth to present a smoother data flow buffer process that protects the progress bar of the above method for progress bar control from external influences to improve self-adaptability.

As shown in FIG. 2, in one embodiment of the present disclosure, the step S150 includes:

Step S151, self-increasing the current buffer progress based on the variation of the progress bar.

In the embodiment, self-increase after obtaining the variation of the progress bar by reducing order, and get the sum of acquired current buffer progress and the variation of the progress bar as a new current buffer progress.

Step S153, refreshing the current buffer progress reflected in the progress bar of the application according to the current buffer progress from the self-increase operation.

In the embodiment, refresh the progress in the progress bar to the current buffer progress after the self-increase operation, to reflect the buffer process of the data flow in the application.

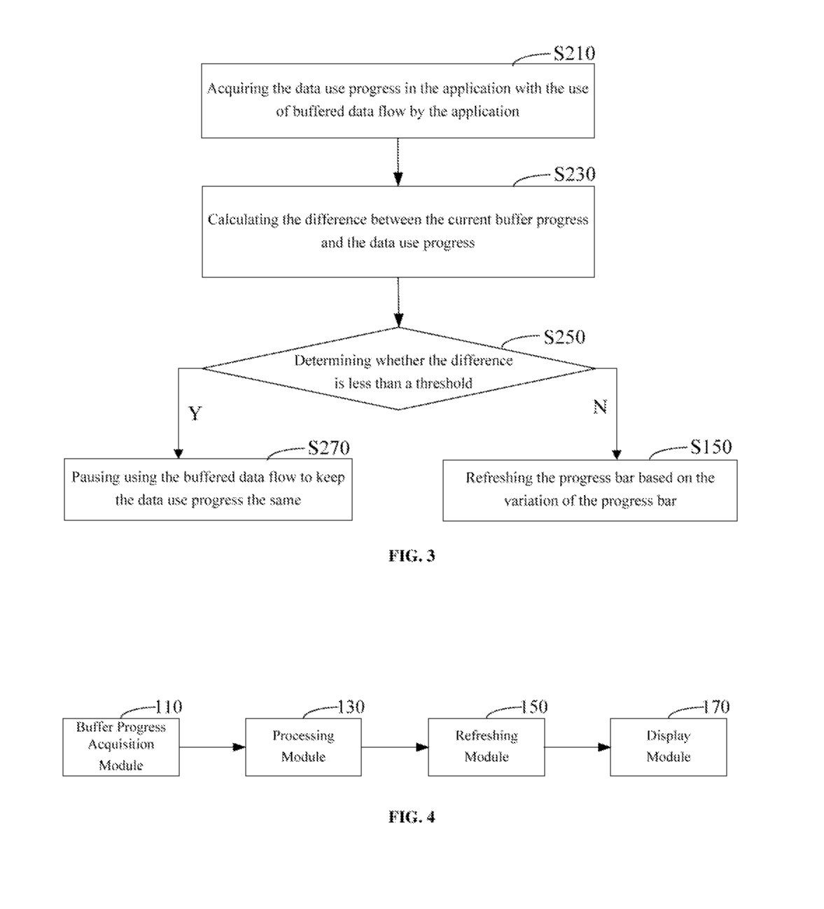

As shown in FIG. 3, in one embodiment of the present disclosure, the above method for progress bar control also includes:

Step S210, acquiring the data use progress in the application with the use of buffered data flow by the application.

In the embodiment, the application will use the buffered data flow in the process of downloading data from the network server or loading data stored in the local to a memory.

For example, for an application of media files playing online, in the process of downloading video stream or audio stream of media files from the network server, display the downloaded video stream or audio stream in the play interface, at the moment, the play progress of the video stream or audio stream in the play interface can be acquired, and the progress is data use progress.

For a game application, in the process of downloading data flow of the game from the network server or reading local data flow, and buffering into a memory, load the game page by the downloaded or buffered data flow, at the moment, the loading progress of the game page can be acquired, and the progress is data use progress.

Step S230, calculating the difference between the current buffer progress and the data use progress.

In the embodiment, the data flow used by the application in the process of using the data must be buffered data flow, so the data use progress must be less than or equal to the current buffer progress, and a chase situation must be presented between the data use progress and the current buffer progress.

Step S250, determining whether the difference is less than a threshold. If it is, then proceed to the step S270, otherwise, proceed to the step S150.

In the embodiment, if the difference between the current buffer progress and the data use progress is determined to be less than the threshold, it means that the buffered data flow is about to run out, at the moment, the application is paused to wait for the buffer of the data flow until the difference between new current buffer progress and current unchanged data use progress is greater than the threshold.

For example, for an application of media files playing online, if the difference between the current buffer progress and the data use progress is determined to be less than the threshold, it means that buffered data flow of the current playing media files is about to end, so the playing is paused to wait for buffering the data flow of the media files to be buffered until the difference between new current buffer progress and current unchanged data use progress is greater than the threshold.

Step S270, pausing the buffered data flow to keep the data use progress the same.

In one embodiment of the present disclosure, the above step S150 includes:

refreshing the data use progress reflected in the progress bar of the application based on the data use progress.

In the embodiment, refresh the progress bar of the application based on constantly changing data use progress, to make the progress bar reflect the current data use progress.

In the above method for progress bar control, the current buffer progress and the data use progress are reflected by progress bar, so the current buffer progress and the data use progress of data flow in the application can be reflected by one progress bar that the double buffering of the progress bar can be implemented without setting two progress bars to reflect the current buffer progress and the data use progress of data flow in the application respectively.

In another embodiment of the present disclosure, the above method for progress bar control also includes:

acquiring the actual buffer progress, the current buffer progress and data use progress according to a preset frequency.

In the embodiment, preset a certain frequency, acquire the actual buffer progress, the current buffer progress and data use progress of the data flow in the application according to the preset frequency, and refresh the current buffer progress and data use progress in the progress bar according to the preset frequency.

The above method for progress bar control may be best understood by reference to the following description taken in conjunction with one specific embodiment. In the embodiment, for an application for playing video online, in the process of playing the video file, video streaming is pulled from the network server, at the moment, the download process of the video streaming is the actual buffer progress.

The current buffer progress is a progress corresponding to the actual buffer progress lazy loading in the progress bar by the application for playing video online.

In the process of downloading and playing the video flow, acquire an actual buffer progress and a current buffer progress, reduce a difference between the actual buffer progress and the current buffer progress to a lower order to obtain a variation of a progress bar, and refresh the progress bar based on the variation of the progress bar.

In addition, the data use progress in the progress bar also can be acquired. Because the constrained relationship between the data use progress and the current buffer progress is that the data use progress does not extend beyond the current buffer progress, determine whether the difference between the current buffer progress and the data use progress is less than a threshold, if it not, refresh the progress bar, taking the current play progress of the video stream as the data use progress.

Through the above progress bar control in the application for video playing online, the progress bar can reflect the current buffer progress and data use progress, and the change of the current buffer progress is smooth, for example, it can be seen by the user that 10% to 40% in the progress bar is evenly divided into a plurality of changes, 40% to 80% is also evenly divided into a plurality of refresh, and the data use progress reflected in the progress bar chases the current buffer progress to implement the self-adaptability of the progress bar.

As shown in FIG. 4, in one embodiment of the present disclosure, a device for progress bar control includes a buffer progress acquisition module 110, a processing module 130, a refreshing module 150 and a display module 170.

The buffer progress acquisition module 110 is configured to acquire an actual buffer progress and a current buffer progress from a data flow in an application.

In the embodiment, the application can be an application that requires data buffering and loading and is provided with a progress bar, for example, the application can be an application for playing media online, or a application that is loading a page and provided with a progress bar reflecting the progress in the loading page, too many to mention here.

The actual buffer progress of a data flow is a download progress of the data flow or a progress that buffers data flow from local to memory, while the current buffer progress is a data flow buffer progress corresponding to the progress bar of the application.

The buffer progress acquisition module 110 acquires actual buffer progress from the data buffer in the application, and obtains the current buffer progress by the progress bar of the application.

With the buffering of data in the application, the corresponding actual buffer progress and current buffer progress are constantly changing, for example, when a browser is loading a webpage game, the actual buffer progress will changes with the download progress of the data flow, while the current buffer progress is a progress corresponding to the progress bar in the webpage.

Further, depending on the source of data flow, the actual buffer progress of the data flow can be a download progress of the data flow or a progress that buffers data flow from local to memory. If the data flow comes from a network server, the application pulls data from the network server, and the actual buffer progress is a download progress for downloading from the network server accordingly. If the data flow is data stored in the local, it can not be buffered in a memory at once and needs a certain time to be loaded into memory, and the actual buffer progress is a ratio of data loaded into memory to actual data.

The processing module 130 is configured to reduce a difference between the actual buffer progress and the current buffer progress to a lower order to obtain a variation of a progress bar.

In the embodiment, the processing module 130 subtracts the current buffer progress from the actual buffer progress, yields the difference between actual buffer progress and the current buffer progress, and reduces the difference to a lower order to obtain a variation of a progress bar, where the variation of the progress bar reduced to a lower order is not greater than the difference, which is used to indicate the actual variation of the progress bar.

The processing module 130 reduces the difference between the actual buffer progress and the current buffer progress to a lower order, to be helpful for reducing the influence of various external factors, for example the impact of the situation of network on the progress bar. Specifically, under a very good network condition, the actual buffer progress is changing rapidly under the influence of network condition, and the current buffer progress is a progress reflected in the progress bar and corresponding to the actual buffer progress before the changes, at the moment, the difference between the actual buffer progress and the current buffer progress is larger, namely, the better the network condition is, the greater the difference is. If refresh the progress bar directly from the difference, the progress bar will be suddenly changed, so the processing module 130 reduces the difference to a lower order to refresh the progress bar based on the reduced progress bar, which makes the current buffer progress in the progress bar increase smooth.

Further, the processing module 130 presets an optimal variation value, and reduces the difference to a lower order based on the optimal variation value. The algorithm for reducing order of the difference can be flexible, for example, divide the difference by the factorial of 2, take remainders of the difference, or take remainders of the difference before divide the difference by the factorial of 2.

The refreshing module 150 is configured to refresh the progress bar based on the variation of the progress bar.

In the embodiment, the refreshing module 150 learns the actual variation of the progress bar by the variation of the progress bar, and refreshes the progress bar of the application based on the actual variation.

The display module 170 is configured to display the refreshed progress bar.

In the embodiment, the display module 170 displays the refreshed progress bar in the page of the application to reflect the progress to users.

In the above device for progress bar control, lazy load the actual buffer progress of data flow in the application to the progress bar, to make the current buffer progress of the progress bar change smooth to present a smoother data flow buffer process that protects the progress bar of the above method for progress bar control from external influences to improve self-adaptability.

As shown in FIG. 5, in one embodiment of the present disclosure, the above refreshing module 150 includes a self-increasing unit 151 and a buffer refreshing unit 153.

The self-increasing unit 151 is configured to self-increase the current buffer progress based on the variation of the progress bar.

In the embodiment, the self-increasing unit 151 self-increases after obtaining the variation of the progress bar by reducing order, and gets the sum of acquired current buffer progress and the variation of the progress bar as a new current buffer progress.

The buffer refreshing unit 153 is configured to refresh the current buffer progress reflected in the progress bar of the application according to the current buffer progress from the self-increase operation.

In the embodiment, the buffer refreshing unit 153 refreshes the progress in the progress bar to the current buffer progress after the self-increase operation, to reflect the buffer process of the data flow in the application.

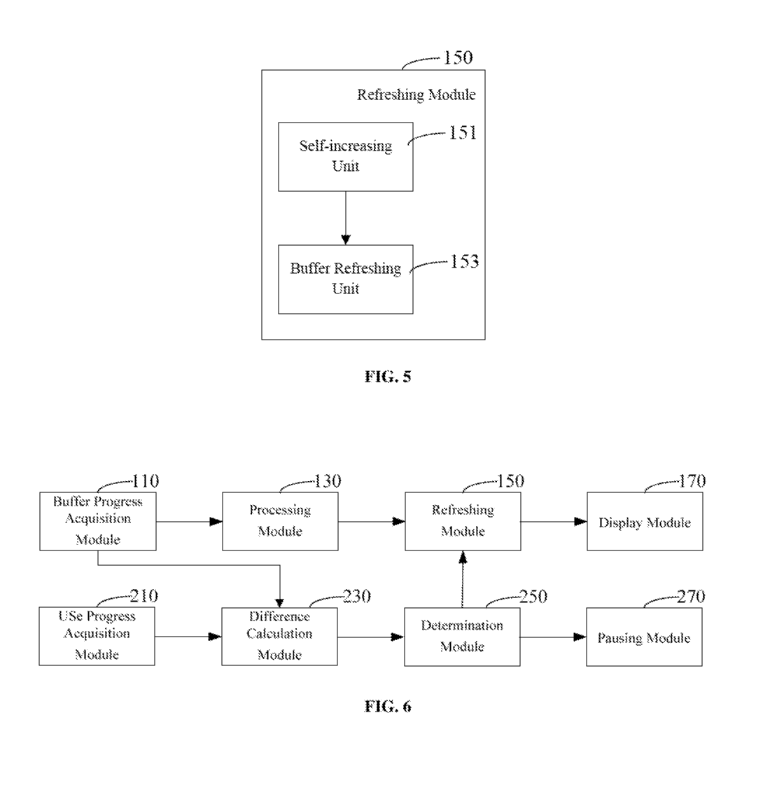

As shown in FIG. 6, in one embodiment of the present disclosure, the above device for progress bar control also includes a use progress acquisition module 210, a difference calculation module 230, a determination module 250 and a pausing module 270.

The use progress acquisition module 210 is configured to acquire the data use progress in the application with the use of buffered data flow by the application.

In the embodiment, the application will use the buffered data flow in the process of downloading data from the network server or loading data stored in the local to a memory.

For example, for an application of media files playing online, in the process of downloading video stream or audio stream of media files from the network server, display the downloaded video stream or audio stream in the play interface, at the moment, the use progress acquisition module 210 acquires the play progress of the video stream or audio stream in the play interface, wherein the progress is data use progress.

For a game application, in the process of downloading data flow of the game from the network server or reading local data flow, and buffering into a memory, load the game page by the downloaded or buffered data flow, at the moment, the use progress acquisition module 210 acquires the loading progress of the game page, wherein the progress is data use progress.

The difference calculation module 230 is configured to calculate the difference between the current buffer progress and the data use progress.

In the embodiment, the data flow used by the application in the process of using the data must be buffered data flow, so the data use progress must be less than or equal to the current buffer progress, and a chase situation must be presented between the data use progress and the current buffer progress.

The determination module 250 is configured to determine whether the difference is less than a threshold. If it is, then inform the pausing module 270, otherwise, inform the refreshing module 150.

In the embodiment, if the difference between the current buffer progress and the data use progress is determined to be less than the threshold by the determination module 250, it means that the buffered data flow is about to run out, at the moment, the pausing module 270 is informed to paused to wait for the buffer of the data flow until the difference between new current buffer progress and current unchanged data use progress is greater than the threshold.

For example, for an application of media files playing online, if the difference between the current buffer progress and the data use progress is determined to be less than the threshold by the determination module 250, it means that buffered data flow of the current playing media files is about to end, so the pausing module 270 is informed to paused playing to wait for buffering the data flow of the media files to be buffered until the difference between new current buffer progress and current unchanged data use progress is greater than the threshold.

The pausing module 270 is configured to pause using the buffered data flow to keep the data use progress the same.

The refreshing module 150 is also configured to refresh the data use progress reflected in the progress bar of the application based on the data use progress.

In the embodiment, the refreshing module 150 refreshes the progress bar of the application based on constantly changing data use progress, to make the progress bar reflect the current data use progress.

In the above device for progress bar control, the current buffer progress and the data use progress are reflected by progress bar, so the current buffer progress and the data use progress of data flow in the application can be reflected by one progress bar that the double buffering of the progress bar can be implemented without setting two progress bars to reflect the current buffer progress and the data use progress of data flow in the application respectively.

In one embodiment of the present disclosure, the above device for progress bar control also includes a timer. The timer is configured to acquire the actual buffer progress, the current buffer progress and data use progress according to a preset frequency.

In the embodiment, a certain frequency is preset, the timer acquires the actual buffer progress, the current buffer progress and data use progress of the data flow in the application according to the preset frequency, and the current buffer progress and data use progress in the progress bar are refreshed according to the preset frequency.

The above method and device for progress bar control, in the process of data buffering of an application, acquire an actual buffer progress and a current buffer progress from data in the application, reduce a difference between the actual buffer progress and the current buffer progress to a lower order to obtain a variation of a progress bar, refresh the progress bar based on the variation, and display the refreshed progress bar, to reflect the buffer progress of data in the application. Because the variation of the progress bar is the result of reducing the difference between the actual buffer progress and the current buffer progress to a lower order, and the difference is easily influenced by external factors, such as network environment, reducing the difference to a lower order correspondingly reduces the influence of external factors, and it makes the refreshed progress bar based on the variation of the progress bar both reflect the buffer progress of data in the application and be less susceptible to external factors, such as network environment, so as to effectively control the progress bar.

It will be appreciated for those skilled in the art that parts of or overall process in the above embodiments can be implemented by related hardware controlled by computer program, the computer program can be stored in a computer-readable storage medium, and when the computer program is executed, it can include the processes of the above embodiments of each method. Wherein, the computer-readable storage medium can be a disc, a compact disc, a Read-Only Memory or a Random Access Memory.

The embodiments are chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for progress bar control, comprising:
acquiring an actual buffer progress and a current buffer progress from a data flow in an application;
reducing a difference between the actual buffer progress and the current buffer progress to a lower order to obtain a variation of a progress bar;
refreshing the progress bar based on the variation of the progress bar; and
displaying the refreshed progress bar.

2. The method of claim 1, wherein refreshing the progress bar based on the variation of the progress bar comprises:
self-increasing the current buffer progress based on the variation of the progress bar; and
refreshing the current buffer progress reflected in the progress bar of the application according to the current buffer progress from the self-increase operation.

3. The method of claim 1, further comprising:
acquiring the data use progress in the application with the use of buffered data flow by the application;
calculating the difference between the current buffer progress and the data use progress; and
determining whether the difference is less than a threshold, if it is, then pause using the buffered data flow to keep the data use progress the same, otherwise, proceed to the refreshing of the progress bar based on the variation of the progress bar.

4. The method of claim 3, wherein refreshing the progress bar based on the variation of the progress bar further comprises:
refreshing the data use progress reflected in the progress bar of the application based on the data use progress.

5. The method of claim 3, further comprising:
acquiring the actual buffer progress, the current buffer progress and data use progress according to a preset frequency.

6. A device for progress bar control, comprising:
a buffer progress acquisition module, configured to acquire an actual buffer progress and a current buffer progress from a data flow in an application;
a processing module, configured to reduce a difference between the actual buffer progress and the current buffer progress to a lower order to obtain a variation of a progress bar;
a refreshing module, configured to refresh the progress bar based on the variation of the progress bar; and
a display module, configured to display the refreshed progress bar.

7. The device of claim 6, wherein the refreshing module comprises:
a self-increasing unit, configured to self-increase the current buffer progress based on the variation of the progress bar.
a buffer refreshing unit, configured to refresh the current buffer progress reflected in the progress bar of the application according to the current buffer progress from the self-increase operation.

8. The device of claim 6, further comprising:
a use progress acquisition module, configured to acquire the data use progress in the application with the use of buffered data flow by the application.
a difference calculation module, configured to calculate the difference between the current buffer progress and the data use progress.
a determination module, configured to determine whether the difference is less than a threshold, if it is, then inform the pausing module, otherwise, inform the refreshing module.
a pausing module, configured to pause using the buffered data flow to keep the data use progress the same.

9. The device of claim 8, wherein the refreshing module is further configured to refresh the data use progress reflected in the progress bar of the application based on the data use progress

10. The device of claim 8, further comprising:
a timer, configured to acquire the actual buffer progress, the current buffer progress and data use progress according to a preset frequency.

11. A non-transitory computer-readable storage medium comprising an executable program to execute a method for progress bar control, the method comprising:
acquiring an actual buffer progress and a current buffer progress from a data flow in an application;
reducing a difference between the actual buffer progress and the current buffer progress to a lower order to obtain a variation of a progress bar;
refreshing the progress bar based on the variation of the progress bar; and
displaying the refreshed progress bar.

12. The non-transitory computer-readable storage medium of claim 11, wherein refreshing the progress bar based on the variation of the progress bar comprises:
self-increasing the current buffer progress based on the variation of the progress bar; and
refreshing the current buffer progress reflected in the progress bar of the application according to the current buffer progress from the self-increase operation.

13. The non-transitory computer-readable storage medium of claim 11, wherein the method further comprises:
acquiring the data use progress in the application with the use of buffered data flow by the application;
calculating the difference between the current buffer progress and the data use progress; and
determining whether the difference is less than a threshold, if it is, then pause using the buffered data flow to keep the data use progress the same, otherwise, proceed to the refreshing of the progress bar based on the variation of the progress bar.

14. The non-transitory computer-readable storage medium of claim 13, wherein refreshing the progress bar based on the variation of the progress bar further comprises:
refreshing the data use progress reflected in the progress bar of the application based on the data use progress.

15. The non-transitory computer-readable storage medium of claim 13, wherein the method further comprises:
acquiring the actual buffer progress, the current buffer progress and data use progress according to a preset frequency.
